(19) United States
(12) Patent Application Publication
(10) Pub. No.: US 2003/0091336 A1
(43) Pub. Date: May 15, 2003

(54) Method of copying compressed digital data

(76) Inventor: Jean Gobert, Maisons-Alfort (FR)

Correspondence Address: U.S. Philips Corporation, 580 White Plains Road, Tarrytown, NY, 10591, US

(21) Appl. No.: 10/277,536

(22) Filed: Oct. 22, 2002

(30) Foreign Application Priority Data
Oct. 23, 2001 (FR) 0113673

(51) Int. Cl. H04N 5/76; G11B 15/04; G11B 19/04

(52) U.S. Cl. 386/94; 360/60; 380/201

(57) ABSTRACT

The present invention relates to a method of copying compressed digital data onto an information medium. Said digital data have been compressed by successive fragments according to a scalable compression format, and a fragment according to said format comprises a base layer and at least one improvement layer. The copying method according to the invention comprises a step of eliminating part of the at least one improvement layer. It next comprises a step of copying the improvement layer thus truncated onto a destination information medium. These steps are iterated for all or some of the fragments constituting the digital multimedia signal.

### FIELD OF THE INVENTION

The present invention relates to a method of copying compressed digital data onto an information medium. It also relates to the device corresponding to it..

It finds in particular its application in apparatus allowing the recording on information media of the CD or DVD disc type, of digital data of the compressed audio or video type according to a coding technique such as the MPEG (Motion Pictures Expert Group) standard for example. It relates more particularly to the copying of said compressed digital data with a view to degrading the information which they originally contain.

### BACKGROUND OF THE INVENTION

The digital data coding techniques at the present time make it possible to obtain copies of multimedia works of excellent quality. With the appearance of multimedia digital data recording devices, there is a real risk of seeing large-scale broadcasting of copies of multimedia works with lack of regard for copyright legislation. The risk is all the greater since the copying quality remains constant with each copy generation, unlike analog media such as audio or video cassettes where the quality degrades at each copy generation.

Japanese patent application published under the number 2000-182325 describes a device for copying compressed digital data of the MP3 type onto an information medium of the DVD type. Said device comprises a flash memory containing the compressed digital data. It also comprises a controller and an MP3 decoder, said controller causing the MP3 decoder to decode the compressed digital data contained in the flash memory. Finally, it comprises a deterioration circuit for degrading the quality of the sound at each copy generation by means of a filtering of the decompressed digital data issuing from the MP3 decoder.

Such a device makes it necessary to decode the compressed digital data. It therefore has the drawback of being particularly complex and expensive to implement.

### SUMMARY OF THE INVENTION

The aim of the present invention is to propose a method and device for copying compressed digital data onto an information medium, which are both particularly simple and effective.

To this end, the method of copying compressed digital data according to the invention is characterized in that said digital data have been compressed in successive fragments according to a scalable compression format, a fragment according to said format comprising a base layer and at least one improvement layer, and in that said method comprises a step of eliminating part of at least one improvement layer.

According to said scalable compression format, the digital multimedia signal of optimum quality corresponds to the sum of the base layer and of the at least one improvement layer. Thus, by virtue of the method of copying compressed digital data according to the invention, only part of a fragment of compressed digital data will be preserved for recording, said fragment corresponding for example to an image. This fragment part corresponds, for example, to the base layer, to certain improvement layers and possibly part of an improvement layer. The digital multimedia signal thus obtained will thus be of less quality than the original digital multimedia signal. In addition, the copying method performs the elimination step at each copy generation, which means that the quality of the signal of a copy of a copy is less than that of the copy which served as a basis for the recording.

Another object of the present invention is the implementation of the method of copying compressed digital data, in the form of an integrated circuit for example, using hardware or software means.

### BRIEF DESCRIPTION OF THE DRAWINGS

The invention will be further described with reference to examples of embodiment show in the drawings to which, however, the invention is not restricted.

FIG. 1 illustrates the result of successive copies of compressed digital data according to the copying method of the invention,

FIG. 2 is a diagram depicting a method of transcoding digital data compressed according to a non-scalable compression format into digital data compressed according to a scalable compression format, and

FIG. 3 is a diagram depicting a method of decoding digital data compressed according to a scalable compression format.

### DESCRIPTION OF PREFERRED EMBODIMENTS

The present invention relates to a method of copying compressed digital data onto an information medium with a view to degrading, at each copy generation, the information which they originally contain. The compressed digital data can result from a source information medium or be downloaded from a communication network of the Internet type for example.

The present invention can also be applied to the storage of a set of compressed digital data on an information medium of limited size with a view to being able to store said set in a reduced format, according to the storage capacity available on said medium.

The invention has been developed more particularly in the context of the MPEG standard for digital video signals but other compression techniques are also possible. Thus the copying method according to the invention applies to any digital multimedia signal comprising digital data which have been compressed in successive fragments according to a scalable compression format. A fragment corresponds, for example, to an image in a sequence of images in the case of the MPEG2 standard. A fragment can also correspond to a video object or VOP within the image in the case of the MPEG4 standard. It will be clear to a person skilled in the art that said fragment can correspond to another division of the digital multimedia signal. The invention is particularly advantageous for a scalable compression of the fine grain type, that is to say, when an improvement layer is decodable partially by truncation. Other scalable formats do not allow such flexibility and the improvement layers are to be decoded in whole or not at all, which makes the invention less advantageous but nevertheless applicable.

Each fragment must comprise digital data which have previously been compressed according to the scalable compression format. It may be a case, by way of example, of the scalable compression format defined in the document “International Organisation for Standardisation ISO/IEC JTC1/SC29/WG11 Coding of Moving Pictures and Audio”, N3317, March 2000, FGS Verification Model, a document referred to hereinafter as the FGS standard. The result of the compression of a fragment containing the original digital data is a fragment containing compressed digital data and comprising a base layer and at least one improvement layer. The copying method according to the invention comprises a step of eliminating part of the at least one improvement layer. It next comprises a step of copying the improvement layer thus truncated onto a destination information medium. These steps are iterated for all or some of the fragments constituting the digital multimedia signal.

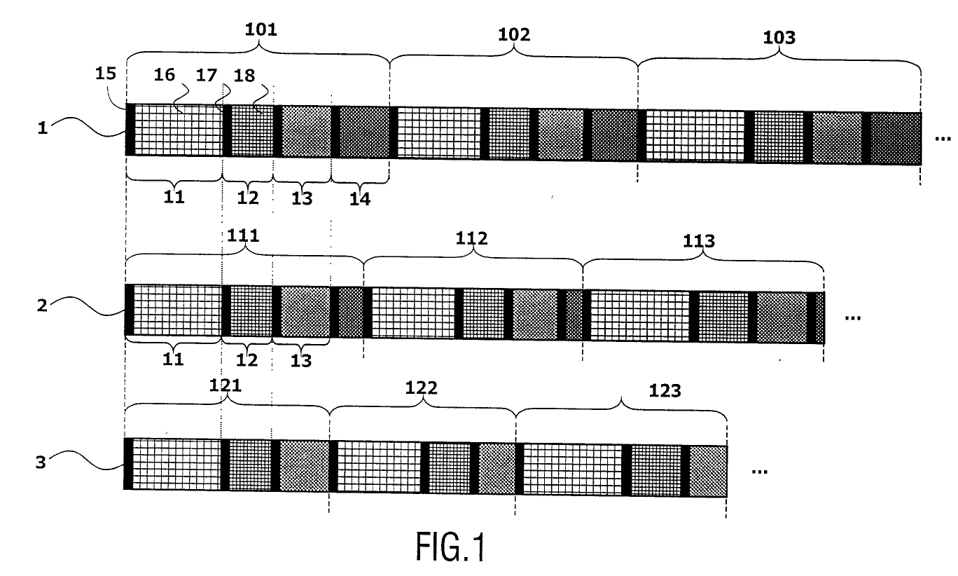

FIG. 1 illustrates the result of successive copies made on an information medium according to the method of copying compressed digital data of the invention. The original digital multimedia signal (1) comprises several fragments (101, 102, 103), each fragment comprising, here sequentially, a base layer (11), consisting of a header (15) and compressed data (16), and improvement layers (12, 13, 14), also each (12) consisting of a header (17) and compressed data (18).

The digital multimedia signal issuing from a first copy (2) consists of successive truncated fragments (111, 112, 113) each comprising a fraction r of the number of bits of the fragments (101, 102, 103) corresponding to them in the original signal. A truncated fragment (111) contains, for example, a base layer (11), two improvement layers (12, 13) and the remainder of an improvement layer (14). This distribution can be different from one fragment to another. This is because the fragments, just like the base and improvement layers which make them up, are of variable size because of the compression. In addition the ratio r may be variable from one fragment to another.

The digital multimedia signal issuing from a second copy (3) consists of successive truncated fragments (121, 122, 123) also each comprising a fragment r of the number of bits of the fragments (111, 112, 113) corresponding to them in the signal issuing from the first copy. The copying method is iterated at each copy generation. As long as the base layer is not truncated in any fragment, decoding remains possible. This is because the base layer is essential for the decoding of the fragment while the improvement layers are eventually added to the base layer corresponding to them.

In the embodiment illustrated in FIG. 1, the suppression step is able to preserve the first m bits among the n bits of the fragment of compressed digital data. In a specific embodiment, the elimination step is able to preserve the first m bits among the n bits of the set of at least one improvement layer so that the base layer is not affected. Just as in the previous case, the ratio r equal to m over n may be fixed or variable for successive fragments depending on whether it is wished to obtain a constant or variable quality of the copied signal. And thus, at each copy generation, only a fraction r of the number of bits of a current fraction or of a current improvement layer, situated at the start of said fragment or of said layer, is preserved. For this purpose, the elimination step is able to identify the start of a fragment or of a set of at least one improvement layer and the start of said fragment or of said set which immediately follows. In the case of a fragment, this identification is made, for example, by means of the parameter picture_start_code situated in a header of the base layer. According to another example, a flow of “metadata” auxiliary data accompanies the flow or flows of compressed digital data, and contains the start address and the length of said fragments or sets of improvement layers. These auxiliary data form part of a system layer, and are used moreover in order to jump from one image to another for example.

The copying method according to the present invention thus has the advantage that the elimination of compressed digital data can be effected with minimum knowledge of the compressed digital data flow, and without complete decoding of said flow. The elimination step can be performed by part of a player/recorder completely independent of the recording itself, such as a file manager for example.

In another embodiment, the elimination step is able to remove the bits corresponding to the last improvement layer or layers, that is to say, an integer number of improvement layers, in particular when these improvement layers cannot be used when they are truncated. In this case, it is necessary to identify the start of the improvement layers. In the FGS standard, there are two improvement layer start parameters, fgs_vop_start_code and fgs_bp_start_code, corresponding respectively to the start of the improvement layer of a video object or VOP within an image, and to the start of an improvement sublayer of said video object. Thus the elimination step is also able to remove bits corresponding to the last improvement sublayer or layers.

In the preferred embodiment, the digital multimedia signal contains digital data directly issuing from a compression according to a scalable coding format. According to a first solution, two compressed digital data flows are available independently of one another, these flows corresponding respectively to a succession of base layers and to a succession of sets of at least one improvement layer. The elimination step is then applied directly to the sets of the second flow cited. According to a second solution, a base layer and the set of at least one improvement layer corresponding to it are multiplexed so as to form a fragment of compressed digital data according to the scalable format, comprising sequentially the base layer and the set of at least one improvement layer. The elimination step is then applied to the fragment according to the principle in FIG. 1.

In a particularly advantageous embodiment, the digital multimedia signal contains digital data which are compressed not according to a scalable compression format but according to a non-scalable compression format of the MPEG type for example. The method of copying compressed digital data then includes a transcoding method able to transform the digital data compressed according to the non-scalable compression format into digital data compressed according to the scalable compression format. Once this transcoding method has been implemented, the transcoded signal will be available in the scalable format for the following copy generations.

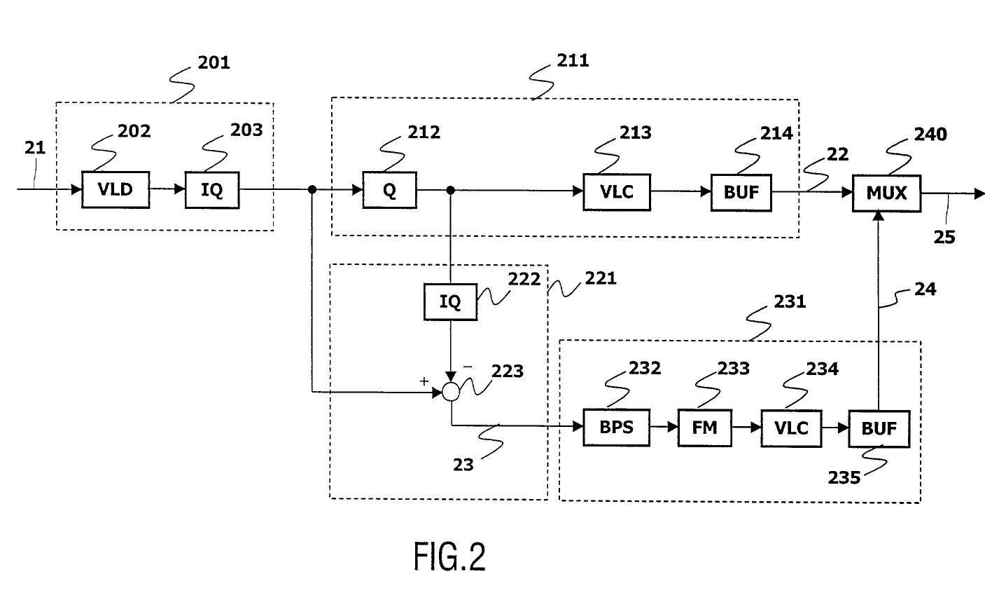

The transcoding method is illustrated in FIG. 2. It comprises the steps of:

error decoding (201), able to decode the digital multimedia signal containing the digital data compressed according to the non-scalable compression format (21) in order to supply decompressed digital data, said error decoding step comprising in series the substeps of variable length decoding VLD (202) and inverse quantization IQ (203) according to a first quantization step q1,

first re-encoding (211), in series with the error decoding step (201), able to deliver compressed digital data corresponding to a base layer (22), said first re-encoding step comprising in series the substeps of quantization Q (212) according to a second quantization step q2 greater than the quantization step q1 in order to degrade the quality of the input signal (21), of variable length coding VLC (213), and of storage BUF (214) of the compressed digital data corresponding to a base layer (22),

reconstruction (221) able to supply a base layer coding error (23), said reconstruction step comprising in series the substeps of inverse quantization IQ (222) of the data issuing from the quantization Q (212), and of subtraction (223) of the data output from the inverse quantization substep IQ (222) from the input data of the quantization substep Q (212),

second re-encoding (231) of the data output from the subtraction step (223), able to deliver compressed digital data corresponding to an improvement layer (24).

According to an embodiment in accordance with the FGS standard, the second re-encoding step processes blocks containing, for example, 8×8 DCT coefficients corresponding to the coding errors (23). It comprises in series the substeps of:

shifting to the left BPS (232) bits defining the DCT coefficients according to their frequency, that is to say according to their position in a block, an 8×8 matrix representing the values of the shifts being stored in the header of the set of improvement layers of a fragment of compressed digital data,

decomposition FM (233) into a minimum of binary planes, the number of binary planes being determined from the largest DCT coefficient after shifting (a DCT coefficient equal to 10 gives, for example, 4 binary planes), the binary planes being formed by an MSB binary plane containing the most significant bits of the DCT coefficients (64 in our example) as far as the LSB binary plane containing the least significant bits of said coefficients,

variable length coding VLC (234) of the binary planes, after conversions of said binary planes into 2D symbols (RUN, EOP), where RUN corresponds to the number of consecutive ‘0’s preceding a ‘1’, and EOP is a binary value corresponding to the presence or absence of ‘1’ in the sequence of the binary plane,

storage BUF (235) of the coded binary planes, an improvement sublayer corresponding in our example to a coded binary plane.

The base layer and the improvement layer are possibly multiplexed (241) so as to form a fragment (25) of digital data compressed according to the scalable format, comprising sequentially the base layer and the improvement layer. They can also, as before, be processed independently subsequently, the elimination step applying only to the improvement layer.

The transcoding method can possibly comprise a movement compensation step, not shown here. The movement compensation step comprises in series a substep of storing in memory coding errors relating to current and previous images and which issue from the reconstruction step (221), which then comprises an inverse transformation step IDCT in series with the subtraction step (223). It also comprises the substeps of movement compensation, DCT transformation, and addition of the signals issuing from the DCT transformation and from the error decoding step (201) in order to supply intermediate data at the first re-encoding step (211).

The method of copying compressed digital data according to the present invention advantageously comprises a control step able to activate (or deactivate) the elimination step if a protection indication is (or is not) inserted in the compressed digital data. The protection indication indicates where the intellectual property rights are present in the compressed digital data and may be inserted, for example, in the header of the base layer. It may also advantageously be inserted according to a watermarking principle. According to this principle, a watermarking signal corresponding to the protection indication is added to the compressed digital data. For compressed digital data of the MPEG type, the watermarking signal is added to the DCT coefficients contained in the compressed digital data flow at the time of coding. Such a method makes it possible to mark the compressed digital data flow on the fly during coding. The watermarking signal being of low amplitude, the quality of the signal is not impaired and the number of bits necessary for compressing the original digital data is not increased or only a little. A protection indication in this form is in addition particularly robust vis-a-vis an attack by a hacker.

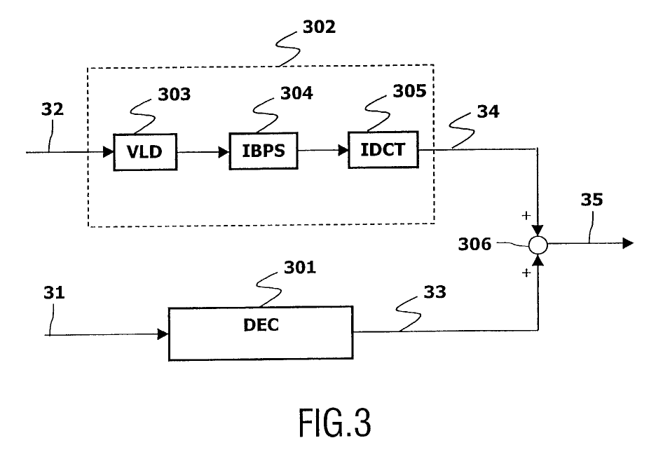

FIG. 3 describes a method of decoding digital data compressed according to a scalable compression format. It is described more precisely in the FGS standard and does not form a part of the present invention but makes it possible to better understand the use of the digital multimedia signal copied according to the copying method according to the invention. The decoding method consists firstly of decoding the base layer (31) and secondly decoding all the improvement layers (32). The base layer is decoded by a standard decoding step DEC (301) which delivers a decoded base layer (33). The set of improvement layers is decoded by a hybrid decoding step (302) which comprises in series the substeps of variable length decoding VLD (303), shifting towards the right BPS (304) bits belonging to the DCT coefficients according to their frequency, and inverse transformation IDCT (305) in order to obtain a set of decoded improvement layers (34). The decoded digital multimedia signal (35) then results from the addition (306) of the decoded base layer (33) and the set of decoded improvement layers (34).

The method of copying compressed digital data can be implemented, in an integrated circuit of the signal processor type for example, by virtue of hardware or software means or a combination of the two. By way of example of hardware implementation, the compressed digital data copying device comprises means of identifying the start of a fragment or all of at least one improvement layer, means of controlling the number of bits copied so as to eliminate a final part of the fragment or of the set of at least one improvement layer, and means of copying the fragment thus truncated. The compressed digital data copying device can in particular be incorporated in a CD or DVD disk burner or in a DVD disk drive/recorder.

It is also possible to implement the steps of the compressed digital data copying method by means of a suitably programmed circuit. A set of instructions contained in a programming memory can cause the circuit to perform the various steps of the compressed digital data copying method previously described.

No reference sign between parentheses in the present text should be interpreted limitingly. The verb “comprise” and its conjugations should also be interpreted broadly, that is to say as not excluding the presence not only of elements or steps other than those listed after said verb, but also of a plurality of elements or steps already listed after said verb and preceded by the word “a” or “an”.

1. A method of copying compressed digital data onto an information medium, characterized in that said digital data have been compressed by successive fragments according to a scalable compression format, a fragment according to said format comprising a base layer and at least one improvement layer, and in that said method comprises a step of eliminating part of the at least one improvement layer.

2. A method of copying compressed digital data as claimed in claim 1, characterized in that the elimination step is able to preserve a fraction of predetermined size of the at least one improvement layer.

3. A method of copying compressed digital data as claimed in claim 1, characterized in that the elimination step is able to eliminate a fraction of the fragment corresponding to an integer number of improvement layers.

4. A method of copying compressed digital data as claimed in claim 1, characterized in that it comprises a step of transcoding digital data compressed according to a non-scalable compression format so as to supply the compressed digital data in a scalable compression format.

5. A method of copying compressed digital data as claimed in claim 1, characterized in that it comprises a control step able to activate the elimination step if a protection indication is inserted in the compressed digital data.

6. A method of copying compressed digital data as claimed in claim 5, characterized in that the protection indication is inserted in the compressed digital data according to a watermarking principle.

7. A device for copying compressed digital data onto an information medium, characterized in that said digital data have been compressed in successive fragments according to a scalable compression format, a fragment comprising a base layer and a set of at least one improvement layer, and in that said device comprises means of identifying the start of the set of at least one improvement layer, and control means able to eliminate part of said set.

8. A “computer program” product for a digital data recorder comprising a set of instructions which, when they are loaded in a circuit of said recorder, causes the latter to implement the digital data copying method according to one of claims 1 to 6.
